(19) United States
(12) Patent Application Publication
(10) Pub. No.: US 2013/0232470 A1
(43) Pub. Date: Sep. 5, 2013

(54) LAUNCHING AN APPLICATION STACK ON A CLOUD PLATFORM ENVIRONMENT

(71) Applicant: John C. Yung, Fremont, CA (US)

(72) Inventor: John C. Yung, Fremont, CA (US)

(21) Appl. No.: 13/411,555

(22) Filed: Mar. 3, 2012

(51) Int. Cl. G06F 9/44

(52) U.S. Cl. 717/121; 717/100

(57) ABSTRACT

An application stack is launched on a cloud platform environment. An application manifest is created for each application in the application stack that is to run in a cloud platform environment. The application manifest includes, for each application, dependency information indicating application relationships and dependencies. The translated application manifests are used to construct the application stack within the cloud platform environment.

### BACKGROUND

Enterprise application software (EAS) is composed of enterprise applications, implemented in software and used in organizations such as in a business or government, that is an integral part of a computer based information system.

Enterprise applications aim to improve an enterprise's productivity and efficiency and are typically implemented as a collection of computer programs with common business applications. Typical examples of such business applications include online shopping, online payment processing, interactive product catalogs, automated billing systems, security and management software for such functions as Information Technology (IT), service, customer relations, resource planning, human resources (HR), manufacturing, automation of business processes and so on. Enterprise applications often display, manipulate and store large amounts of complex data.

Enterprise applications often run in cloud computing environments that support various programming languages, platforms, libraries and interfaces. Within the cloud computing environment, enterprise applications typically must interface successfully with pre-defined protocols and credentials to be operational.

Cloud computing allows the delivery of computing as a service rather than a product, so that shared resources, software, and information can be provided as a metered service over a network (typically the Internet). Computation, software, data access, and storage resources are provided without requiring users to know details of the computing infrastructure. Computing infrastructure typically includes servers, data storage devices, networking equipment and software for information technology infrastructure management, automation and orchestration. End users are typically allowed to access cloud based enterprise applications through a web browser or a mobile app.

Cloud computing allows faster implementation, easier manageability and less maintenance of enterprise applications. The converged infrastructure and shared service available in a cloud computing environment facilitates enterprise IT to adjust resources, such as servers, storage and networking, to meet fluctuations in business demands.

### BRIEF DESCRIPTION OF DRAWINGS

FIG. 1 is a simplified block diagram showing a dynamic application engine and a configuration repository in accordance with an embodiment.

FIG. 2 illustrates operation of an application assembler within a dynamic application engine in accordance with an embodiment.

FIG. 3 is a simplified block diagram showing the form of a dependency and action template in accordance with an embodiment.

FIG. 4 illustrates operation of an infrastructure assembler within a dynamic application engine in accordance with an embodiment.

FIG. 5 is a simplified flowchart illustrating an application is provisioned to run on a cloud computing system in accordance with an embodiment.

FIG. 6 is a simplified example user interface by which a user can select and configure an application stack in accordance with an embodiment.

FIG. 7 is a simplified example user interface by which a user can select a version and configure a database in accordance with an embodiment.

### DETAILED DESCRIPTION

An application stack is a set of applications that interact together to provide services. In order to port an application stack from an original cloud computing environment to a new cloud platform environment it is necessary to make available within the new cloud platform environment the software resources required by the application stack to run in the original cloud computing environment. The resources can include a particular version of an operating system, a particular version of each application with accompanying libraries and plug-is, particular configuration settings, particular additional software code, particular data and so on.

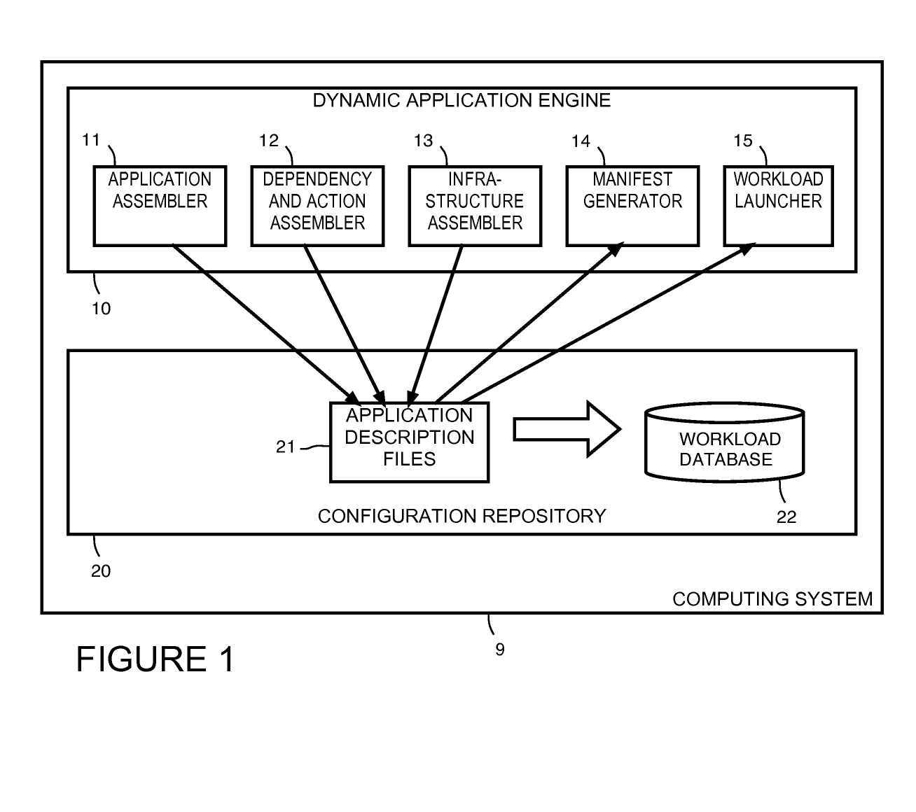

FIG. 1 shows a simplified block diagram showing, within a computing system 9, a dynamic application engine 10 and a configuration repository 20 that together form an application stack launching device that is used to launch an application stack in a cloud platform environment.

The application stack launching device captures information about the operating system, settings, library and platforms for each application in the application stack. The application stack launching device also captures the applications relationships and dependencies. These include, for example, hosts, ports and credentials. The application stack launching device also captures infrastructure dependencies such as firewall rules, server load-balancer and network storage. The application stack launching device generates application manifests and launches application stacks using information captured from the user.

Dynamic application engine 10 includes an application assembler 11, a dependency and action assembler 12, an infrastructure assembler 13, a manifest generator 14 and a workload launcher 15. Configuration repository 20 includes application description files 21 and a workload database 22.

Application assembler 11 captures from the user elements associated with applications. The elements can include, for example, operating system and version 31, application and version 32, libraries and plug-ins 33, configuration settings 34, code location 35 and data locations 36. The information captured is stored as an application manifest. For example, the application manifests are templates in Extensible Markup Language (XML).

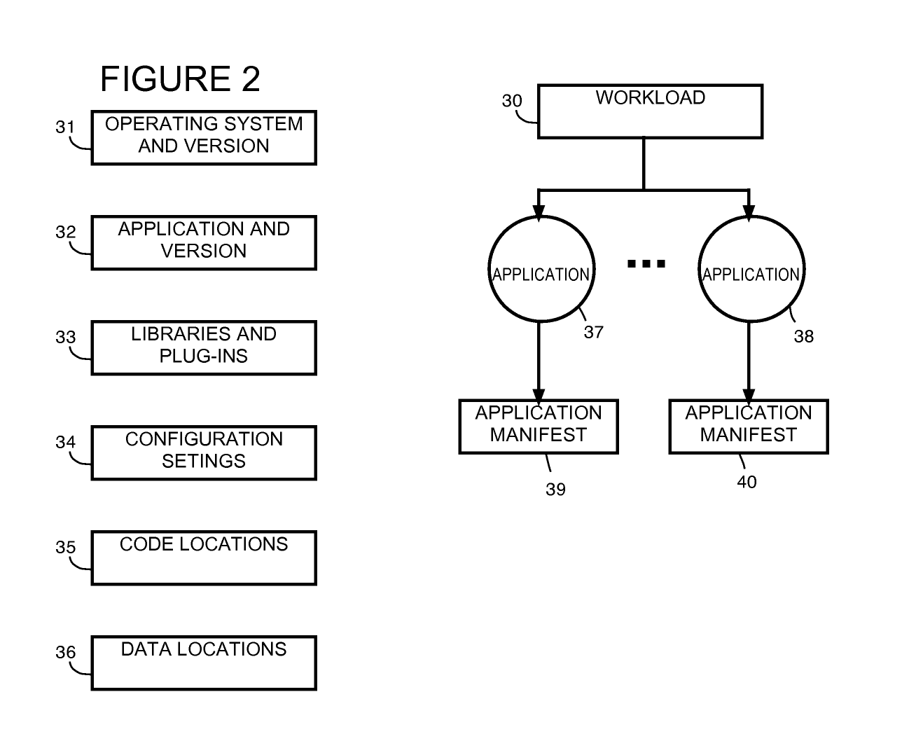

A workload 30 includes application manifests for all applications in an application stack. This is illustrated in FIG. 2, for example, by workload 30 including an application 37 and an application manifest 39 for application 37, and including an application 38 and an application manifest 40 for application 38. The application manifests are stored as part of application description files 21 that are placed in workload database 22, shown in FIG. 1.

Dependency and action assembler 12 assembles dependency information for applications within an application stack. Application dependencies arise, for example, when an application performs services for, requires data from, or provides data to another application. The user interface for dependency and action assembler 12 guides a user to select from a list of available hosts in the application stack. Once selected, the relationship and dependency is stored in the application manifest.

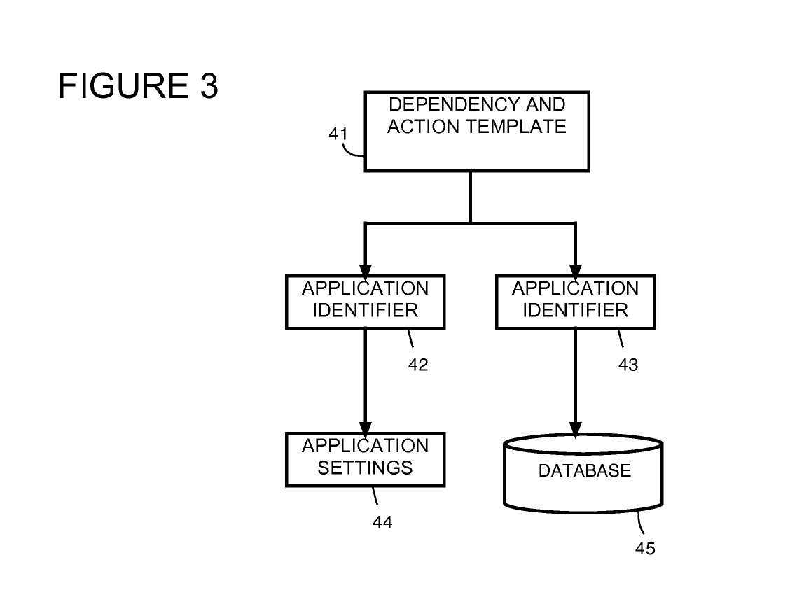

For example, FIG. 3 shows a dependency and action template 41 referencing an application description 42 and an application identifier 43. For example, application identifier 42 may be for the object-relational mapping library for the Java language referred to as Hibernate. Application settings 44 for application identifier 42 may include a database server, a port number, a database name a user name and a password. An application identifier 43 may describe the database referenced by the application identified by application identifier 42. For example, application identifier 42 may by an identifier for a MySQL database 45.

Each dependency setting selected by a user is associated with an action attribute. The action attribute specifies actions to be taken during workload operation. Table 1 below sets out an example list of action attributes and descriptions.

TABLE 1
“keep host”—keep hostname the same
“follow new host”—replace hostname with newly launched host
“keep port”—keep port number the same
“request new port”—request user to enter new network port number
“keep credential”—keep credential the same
“request new credential”—request user to enter new credential

When an application stack is launched in—e.g., as a result of cloning or migration—into a new cloud platform environment, application settings in the application manifest are replaced according to the action attributes included in the application manifest. For example, suppose the action attribute is “follow new host” for a database host “db host”. During a cloning operation, the “db host” setting is replaced with the hostname of the new launched database server that appears in the cloud platform environment into which the application stack is cloned.

Application manifests populated by application assembler 11 and by dependency and action assembler 12 enable seamless mobility of application stacks in real-time cloning or migrating the application stacks into a cloud platform environment.

Table 2 below shows an example of an application manifest written in the form of a template in XML.

TABLE 2

```
<software-config code=“wordpress” version=“3.2.1”
name=“WordPress 3.2.1”>
  <software-config-groups>
    <software-config-group code=“dbconn” name=“Database
Connection”>
      <software-config-items>
        <software-config-item code=“dbname” name=“Database
          Name” type=“String” maxlength=“20”
          default=“wordpress” desc=“Name of the database that
          will be used by WordPress, eg. wordpress”
          oneoff=“true” />
        <software-config-item code=“dbuser” name=“Database
          User” type=“String” maxlength=“20” default=“wpuser”
          desc=“Login of the WordPress database, eg. wpuser”
          required=“true” oneoff=“true” />
        <software-config-item code=“dbpassword”
          name=“Database Password” type=“Password”
          maxlength=“20” desc=“The login password”
          required=“true” oneoff=“true” />
        <software-config-item code=“dbhost” name=“Database
          Server” type=“server-select” maxlength=“4”
          desc=“Choose an instance that installed mysql server”
          required=“true” oneoff=“false” />
      </software-config-items>
    </software-config-group>
  </software-config-groups>
</software-config>
```

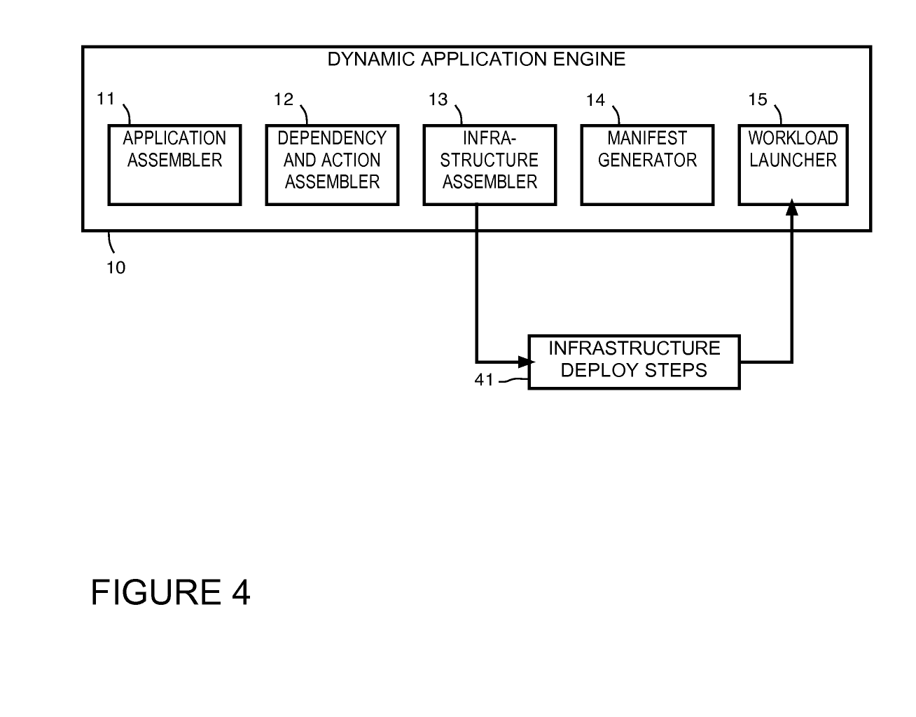

Infrastructure assembler 13, shown in FIG. 1, captures from the user server size information such as central processing unit (CPU) type, memory and storage requirements, security setting information and server load-balancing set-up information. Security setting information includes, for example, firewall rules and other security setting information. Infrastructure assembler 13 instructs workload launcher 15 to perform server and other infrastructure deployments. This is illustrated in FIG. 4 where infrastructure assembler 13 sends infrastructure deploy steps 41 to workload launcher 15.

Manifest generator 14 translates the application manifest written in the form of a template in XML into software, such as the open-source software called Puppet, that can be used by a server automation tool. The application manifest in the Puppet format, or a similar format, may be executed in real time to construct the application stack in a cloud platform environment. Workload launcher 15 executes infrastructure deploy steps 41 and the application manifest in puppet format to construct the application stack in a cloud platform environment. Workload launcher 15 initiates application programming interface (API) calls to specific targets within the cloud platform environment to accomplish each provisioning request in the infrastructure deploy steps 41 and the application manifest.

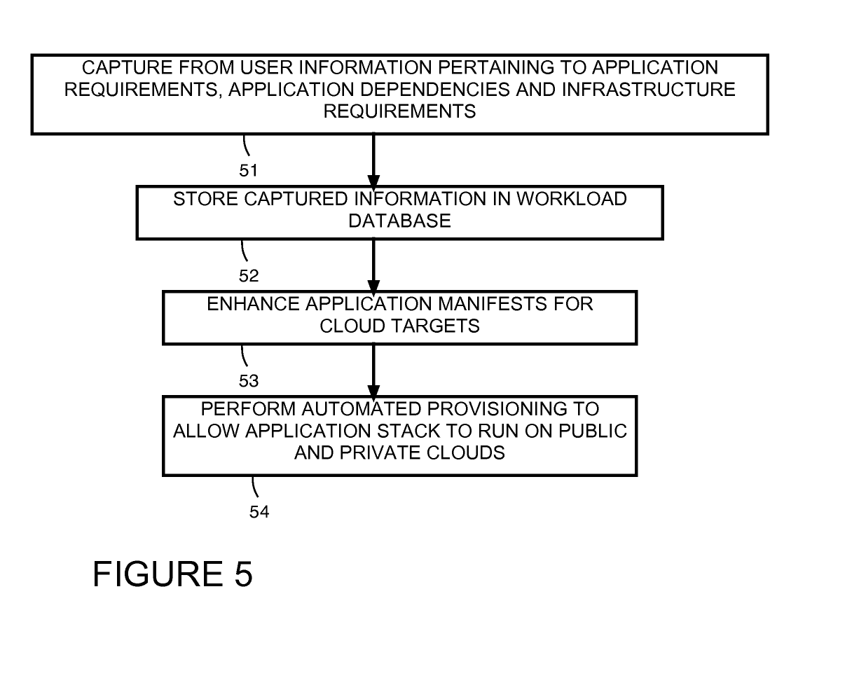

FIG. 5 summarizes operations performed by the application stack launching device. In a block 51, information pertaining to application requirements, application dependencies and infrastructure requirements are captured from a user for all applications in the application stack. In a block 52, the captured information is stored within application descriptions files 21 in workload database 22. In a block 53, the application manifests are enhanced for a target cloud platform environment. In a block 54, automated provisioning is performed to allow the application stack to run on the target cloud platform environment. For example, the target cloud platform environment can be a public target cloud platform environment or a private target cloud platform environment.

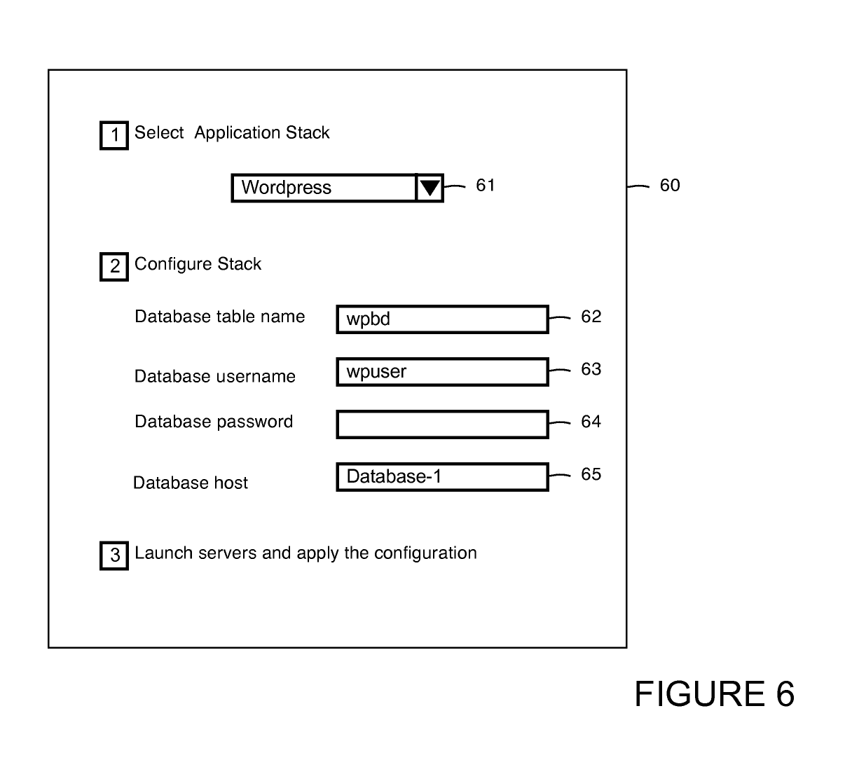

FIG. 6 shows a simplified example user interface 60 in which a user can use a box 61 to select an application. The user can type a database table name in a box 62. The user can type a database username in a box 63. The user can type a password in a box 64. The user can type a database host name into a box 65.

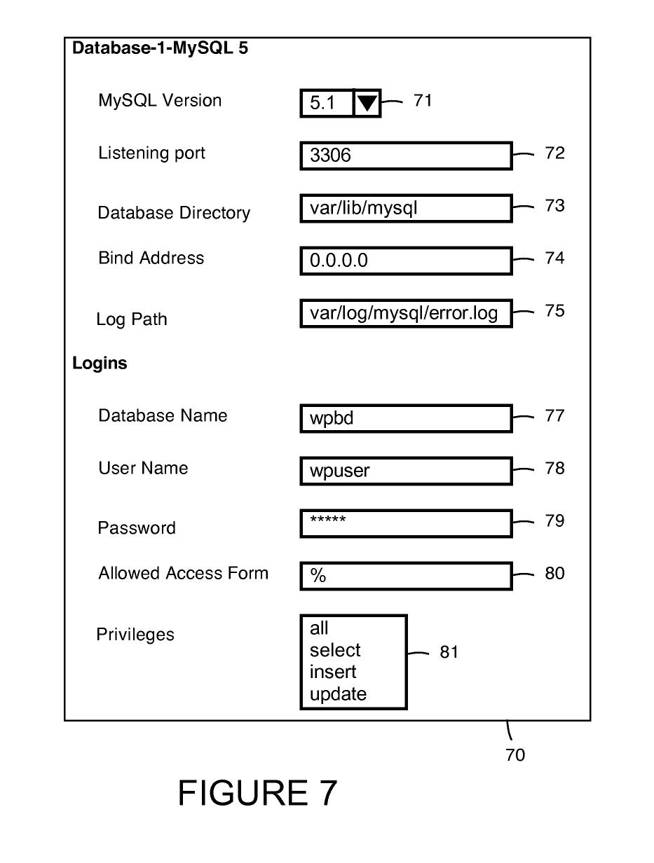

FIG. 7 shows a simplified example user interface 70 in which a user can configure a database. The use can select the database version in a box 71. The user can type a listening port in a box 72. The user can type a database directory in a box 73. The user can type a bind address in a box 74. The user can type a log path in a box 75. The user can type a database name in a box 77. The user can type a user name in a box 78. The user can type a password in a box 79. The user can type an allowed access form in a box 80. The user can select a privilege level in a box 81.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. A dynamic application engine, comprising:
an application assembler that creates an application manifest for each application in an application stack that is to run in a cloud platform environment;
a dependency and action assembler that includes in the application manifest for each application, dependency information indicating application relationships and dependencies;
a manifest generator that translates each application manifest into a format useful to a server automation tool; and,
a workload launcher that utilizes the translated application manifests to construct the application stack within the cloud platform environment.

2. A dynamic application engine as in claim 1 additionally comprising:
an infrastructure assembler, the infrastructure assembler capturing information about application infrastructure and forwarding infrastructure deploy steps to the workload launcher.

3. A dynamic application engine as in claim 1 wherein the application manifest is an Extensible Markup Language (XML) template.

4. A dynamic application engine as in claim 1 wherein the application manifest includes information captured from a user.

5. A dynamic application engine as in claim 1 wherein the application manifest includes information about operating system version, application version, libraries, plug-ins, configuration settings, code location and data.

6. A computer implemented method for launching an application stack on a cloud platform environment, comprising:
creates an application manifest for each application in the application stack;
including in the application manifest for each application, dependency information indicating application relationships and dependencies;
translating each application manifest into a format useful to a server automation tool; and,
utilizing the translated application manifests to construct the application stack within the cloud platform environment.

7. A computer implemented method as in claim 6 additionally comprising:
capturing information about application infrastructure and utilizing the captured information about application infrastructure when constructing the application stack within the cloud platform environment.

8. A computer implemented method as in claim 6 wherein the application manifest is an Extensible Markup Language (XML) template.

9. A computer implemented method as in claim 6 additionally comprising:
capturing from a user information used to create the application manifest.

10. A computer implemented method as in claim 6 wherein the application manifest includes information about operating system version, application version, libraries, plug-ins, configuration settings, code location and data.

11. A device for launching an application stack on a cloud platform environment, comprising:
an application assembler that creates an application manifest for each application in an application stack that is to run in a cloud platform environment;
a dependency and action assembler that includes in the application manifest for each application, dependency information indicating application relationships and dependencies;
a workload launcher that utilizes the application manifests to construct the application stack within the cloud platform environment; and,
an infrastructure assembler, the infrastructure assembler capturing information about application infrastructure and forwarding infrastructure deploy steps to the workload launcher.

12. A device as in claim 11 additionally comprising:
a manifest generator that translates each application manifest into a format useful to a server automation tool.

13. A device as in claim 11 wherein the application manifest is an Extensible Markup Language (XML) template.

14. A device as in claim 11 wherein the application manifest includes information captured from a user.

15. A device as in claim 11 wherein the application manifest includes information about operating system version, application version, libraries, plug-ins, configuration settings, code location and data.
